(19) United States
(12) Patent Application Publication
(10) Pub. No.: US 2006/0073277 A1
(43) Pub. Date: Apr. 6, 2006

(54) Method for producing a partially metallized film-type element

(75) Inventors: Ludwig Brehm, ADELSDORF (DE); Heinrich Wild, Herzogenaurach (DE); Mathias Thater, Schwabach (DE)

Correspondence Address: HOFFMANN & BARON, LLP, 6900 JERICHO TURNPIKE, SYOSSET, NY, 11791, US

(73) Assignee: LEONARD KURZ GMBH & CO. KG, FURTH (DE)

(21) Appl. No.: 10/536,046

(22) PCT Filed: Nov. 20, 2003
(86) PCT No.: PCT/DE03/03847

§ 371 Date: May 18, 2005

(30) Foreign Application Priority Data
Nov. 20, 2002 (DE) 102 54 029.2

(51) Int. Cl. B05D 5/00

(52) U.S. Cl. 427/256

(57) ABSTRACT

The invention concerns a process and an apparatus for the production of a partially metallised film element and a partially metallised film element produced by means of the process. A digital data set (332) which defines the graphical shape of the partial metallisation is produced. A tool path and control data for actuation of a tool (38) are calculated from the digital data set (332). The tool (38) and a single-layer or multi-layer film body (30) are moved relative to each other in accordance with the tool path. The tool (38), controlled by the control data, produces partial digital demetallisation of a metal layer (31), in particular by applying an etching agent or an etching resist or by erosion of the metal layer (31).

The invention concerns a process and an apparatus for the production of a partially metallised film element, in particular a stamping film, a laminating film or an optically variable security element and a partially metallised film element, in particular a stamping film, a laminating film or an optically variable security element.

WO 99/13157 describes a partially metallised security film for securities and bonds and a process for the production of such a film. Such a security film for incorporation in or application to securities or bonds comprises a translucent carrier film and a metallic coating which is applied thereto and which has metal-free regions. To produce that partially metallised film, a carrier film is partially printed upon by means of an intaglio printing process using printing ink with a high proportion of pigment and then the printing ink is dried to form a porous, raised application of ink. A thin metallic cover layer is then formed on the carrier film to which printing is applied in that way. Then the cover layer which lies over the application of ink or which has penetrated thereinto is removed by washing out with a liquid, possibly in combination with a mechanical action. The carrier film is then dried and possibly cut to size. Accordingly what remains on the carrier film, in the regions not originally provided with printing ink, is the metallic cover layer which can be of a thickness of between 0.01 μm and 1 μm.

WO 02/31214 A1 discloses a further possible way of producing a partially metallised film. In that process firstly a carrier material is cleaned and nucleated. That process step is a prerequisite for good adhesion of the partially structured metal layer to the carrier material.

Prior to application of the actual functional layer, an ink which is soluble in any solvent, for example water, alcohol, ketone or ester, is applied by means of an intaglio printing process. A cleaning and nucleation step is then carried out:

The printed substrate is treated by means of an INLINE plasma or corona process. That treatment provides that the film surface is freed of coloring residues from the printing inks and activated at the same time as terminal polar groups are produced. In addition, at the same time as the plasma preliminary treatment in a vacuum, a thin metal or metal oxide layer is also applied as a bonding agent by sputtering or vapor deposition. In particular Cr, Al, Ag, Ni, Cu, Ti, TiO₂, SiOₓ, and CrOₓ are suitable for that purpose.

A Cu layer is then applied to form the pattern layer on the carrier film. The ink is then removed by a mechanical washing operation to obtain the desired structuring. There then follows galvanic post-reinforcement of that pattern layer, forming a metallic reinforcing layer on the pattern layer.

The object of the present invention is now that of providing a partially metallised film element which is particularly inexpensively produced, in particular a partially metallised stamping film or laminating film.

That object is attained by a process for the production of a partially metallised film element in which a digital data set is produced, which defines the graphical shape of the partial metallisation, a tool path and control data for actuation of a tool are calculated from the digital data set, the tool and a single-layer or multi-layer film body are moved relative to each other in accordance with the tool path, and the tool controlled by the control data produces partial demetallisation of a metal layer, in particular by applying an etching agent or an etching resist or by erosion of the metal layer. That object is further attained by a partially metallised film element, in particular a stamping film or a laminating film, which is produced in accordance with the above-described process. That object is further attained by an apparatus for the production of a partially metallised film element, which has a control device, one or more guide devices and at least one tool, wherein the control device calculates from a digital data set which defines the graphical shape of the partial metallisation a tool path and control data for actuation of the tool, the one or more guide devices move the tool and a single-layer or multi-layer film body relative to each other in accordance with the tool path, and the tool controlled by the control data produces partial digital demetallisation of a metal layer, in particular by applying an etching agent or an etching resist or by erosion of the metal layer.

In this respect the invention can be used not only for the production of stamping films or laminating films but also for the production of any kinds of decorative or functional films which have a partially shaped metal layer. An example in that respect is inmold films which are used for decoration of three-dimensional articles by means of the inmold process.

The invention can also be used for the production of an optically variable security element which can be applied by means of a transfer process to a security product, for example to a banknote, a credit card, a cash card or a document. There is also the possibility of applying that optically variable element as a security or authenticity identification to an article, for example a CD or packaging.

The invention achieves the advantage that the production of partially metallised film elements can be substantially automated and thus on the one hand the speed of the production process is increased and on the other hand the costs of the production process are reduced.

In addition with this process it is possible to forego the use of expensive tools such as for example intaglio printing screen cylinders. It is possible to react more flexibly to changes in production, whereby the costs of the production process are further reduced. Further advantages are afforded in the area of security uses. The production of an intaglio printing screen cylinder requires the involvement of a specialist supplier.

Further advantages are afforded by virtue of the fact that it is possible to individualise film elements in a simple fashion by changes to the digital data set. That gives rise to particular advantages in regard to small-scale mass production and image- and data-variable information. A saving in cost is further achieved if no reproduction is required and working operations in respect of the preliminary printing stages are eliminated.

Advantageous configurations of the invention are set forth in the appendant claims.

It is desirable for a film base body firstly to be provided with a metal layer and then for an etching agent to be applied to the metal layer under digital control with the tool for partial demetallisation of the metal layer. The etching agent is removed after partial demetallisation. Alternatively it is possible for the film base body to be provided with a metal layer and for an etching resist then to be applied under digital control with the tool for partially covering the metal layer. The non-covered metal layer is then removed by demetallisation. It is further possible for a washing mask to be applied to the film base body under digital control with the tool for partially covering the film body and for the film body only then to be provided with a metal layer. The metal layer is then partially removed by a washing process in the region of the washing mask.

The above-described variants are distinguished by a high working speed. In addition the process steps required to carry out those processes can be easily integrated into already existing production processes for partially metallised film elements or can be combined with such processes. In addition there can be further cost advantages according to the respective problem involved.

It is also advantageous for the film base body to be provided with a metal layer and for the metal layer then to be removed by the tool by means of spark erosion.

Such an operating procedure affords cost advantages-as it is possible to avoid the use of etching agents, etching resist and so forth. Moreover the number of necessary process steps is reduced so that the film element production time is reduced.

It has proven to be particularly advantageous if a carbon pin as the tool is moved in accordance with the tool path over the single-layer or multi-layer film body and in accordance with the control data a potential difference is generated between the carbon pin and a ground contact element for partial erosion of the metal layer. In that respect particularly good results are achieved for erosion of a metal layer comprising aluminum with a potential difference of between 3 and 4 V and particularly good results are achieved with a potential difference of about 6 V for erosion of a metal layer comprising chromium.

Particularly good processing results can further be achieved by the arrangement of the carbon pin and the ground contact element being taken into account when calculating the tool path and/or the control data.

It has further proven to be desirable for the tool to partially erode the metal layer by means of a laser beam.

In that respect the tool can apply- the etching agent, the etching resist or the washing mask to the film body by means of a roller. It is also possible for the tool to apply the etching agent, the etching resist or the washing mask to the film body by spraying thereon.

It has been found that the process according to the invention is particularly well suited for the production of partial metal layers which are of a thickness of less than 1 μm.

Applying the metal layer to the film body over the full surface area thereof affords the advantage that it is possible to use particularly simple and inexpensive processes such as vapor deposition of the metal layer. However partial application of the metal layer over part of the surface area involved (for example by printing thereon with metal pigments) can also afford advantages for certain situations of use. Thus it is possible to provide a metal layer only on such regions for which the metallisation is also in fact later to be substantially retained. Under some circumstances, with such partial application of the metal layer, it is possible to further expedite the processing time and to save considerable amounts of etching agent, etching resist and the like.

The metal layer which is digitally demetallised by means of the process according to the invention can not only comprise metal and metal alloys but also any other highly reflective materials. Accordingly the term metal layer in accordance with the invention is to be interpreted as meaning a layer which comprises a highly reflective material.

The invention is illustrated by way of example hereinafter by means of a number of embodiments with reference to the accompanying drawing in which:

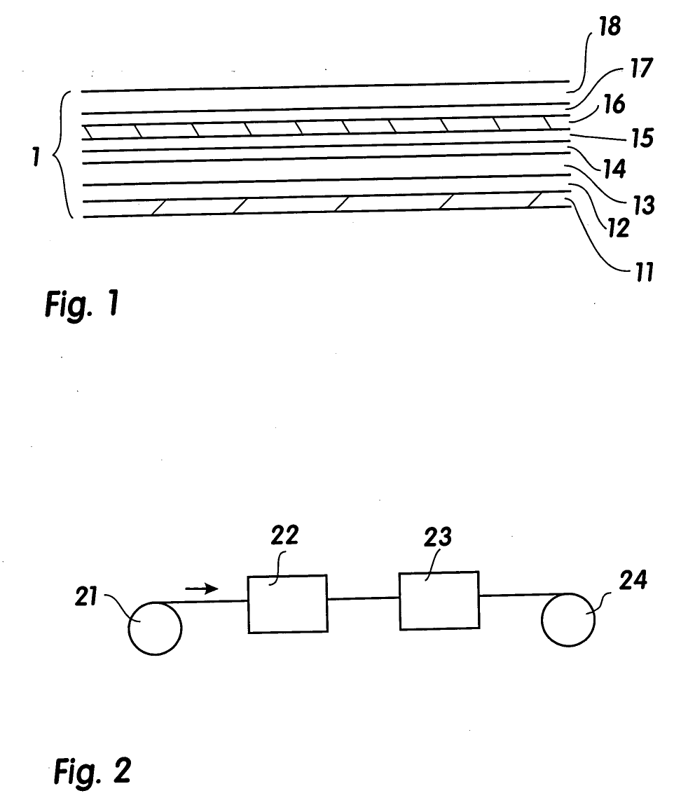

FIG. 1 shows a diagrammatic cross-section through a partially metallised film element according to the invention,

FIG. 2 shows a diagrammatic view of a production process according to the invention for a first embodiment,

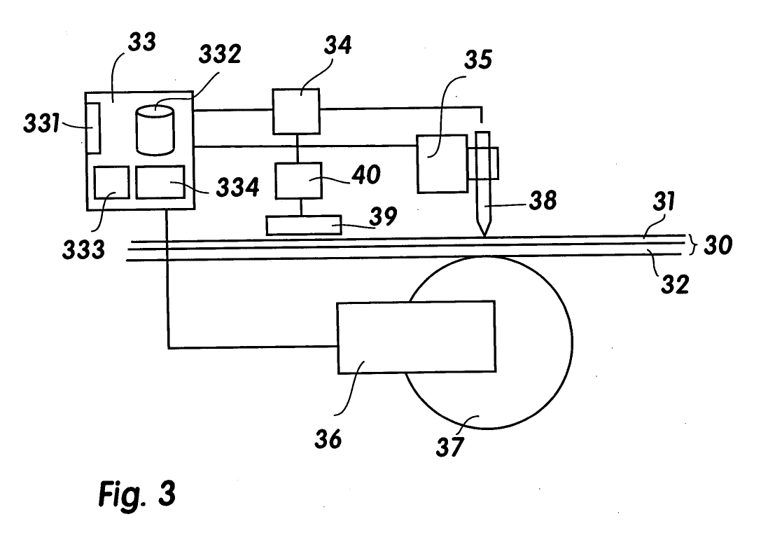

FIG. 3 shows a block circuit diagram of an apparatus according to the invention for the production of a partially demetallised film element,

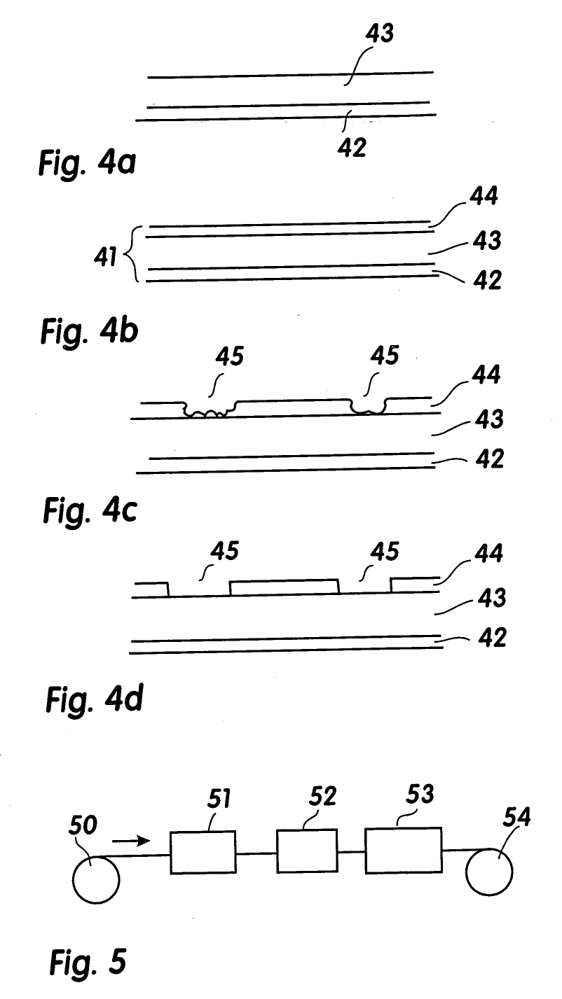

FIGS. 4a through 4d show diagrammatic cross-sections through film elements to illustrate a production process according to the invention in accordance with a second embodiment of the invention,

FIG. 5 shows a diagrammatic view of the production process according to the invention in accordance with the second embodiment of the invention,

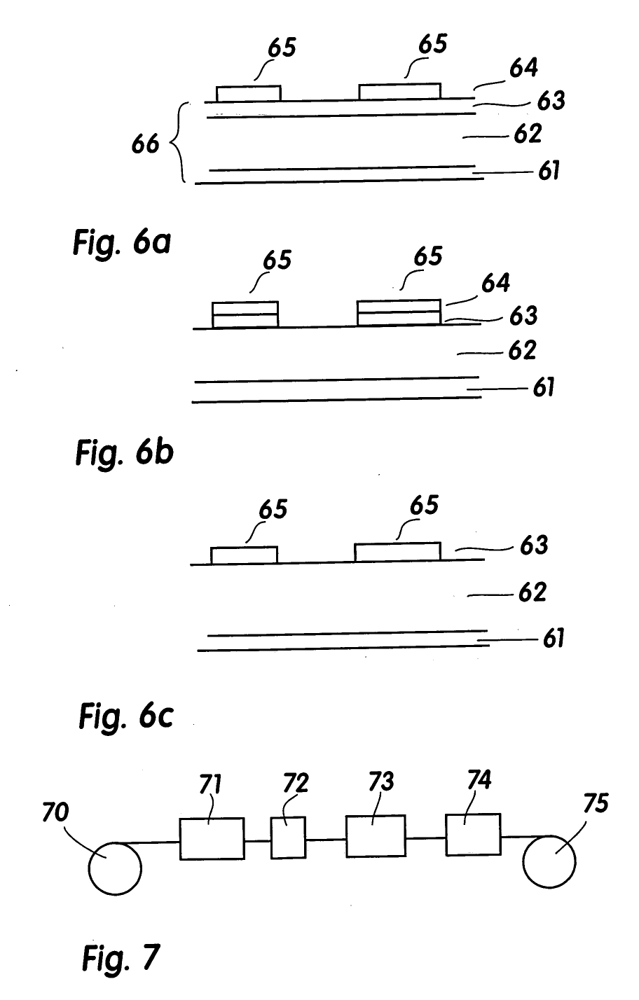

FIGS. 6a through 6c show diagrammatic cross-sections through film elements to illustrate a production process according to the invention in accordance with a third embodiment of the invention,

FIG. 7 shows a diagrammatic view of the production process in accordance with the third embodiment of the invention,

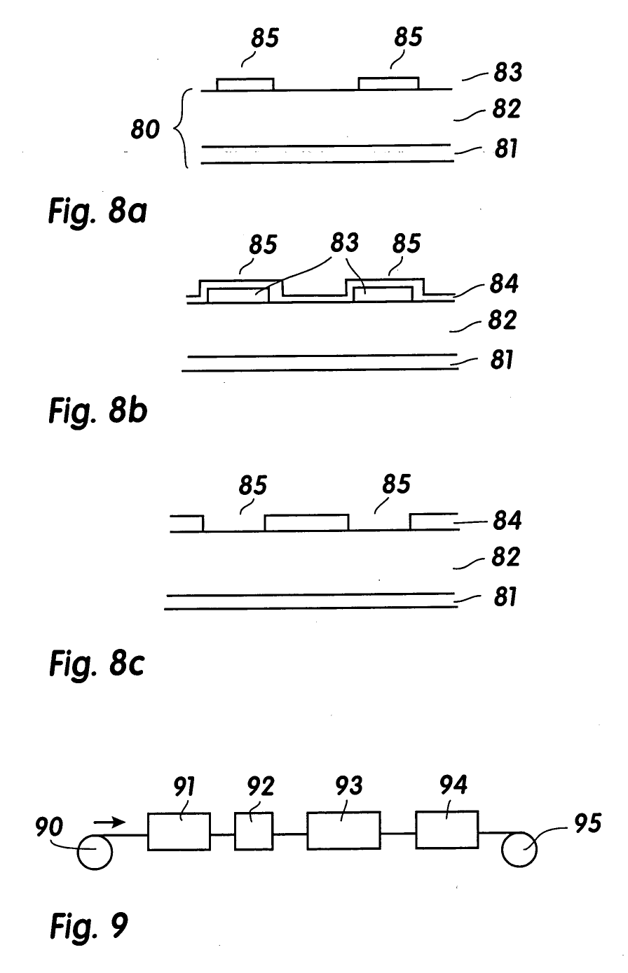

FIGS. 8a through 8c show diagrammatic cross-sections through film elements to illustrate a production process according to the invention in accordance with a fourth embodiment of the invention, and

FIG. 9 shows a diagrammatic view of the production process in accordance with the fourth embodiment of the invention.

FIG. 1 shows a film element 1 which comprises a carrier layer 11, a protective lacquer and/or release layer 12, a replication layer 13, an absorption layer 14, a spacer layer 15, a partial reflection layer 16, a bonding agent layer 17 and an adhesive layer 18.

The film element 1 is a stamping foil, in particular a hot stamping foil, by means of which a decorative element formed by the layers 12 through 18 is applied. The carrier layer 11 comprises for example PET. It serves for application of the optically variable element to the object to be safeguarded in production engineering, and is removed in the appropriate manner after application of the optically variable element to the object to be safeguarded.

The replication layer 13 comprises a thermoplastic material. One or more diffractive structures are embossed into the replication layer 13 into the thermoplastic material thereof by means of a stamping tool. Those diffractive structures are preferably structures which produce holograms and the like by means of diffraction effects. It is however also possible that, instead of diffractive structures, matt structures, macrostructures, achromatic-symmetrical structures, for example sine gratings, achromatic-asymmetrical structures, for example blaze structures or kineforms, are embossed into the layer 13.

The layers 14, 15 and 16 form a thin film layer sequence which by means of interference produces viewing angle-dependent color shifts. Besides the possibility shown in FIG. 1 of making up such a thin film layer sequence from an absorption layer (preferably with between 30 and 50% transmission), a transparent spacer layer as a color change-producing layer (λ/4 or λ/2 layer) and a reflecting layer, it is also possible to construct such a thin film layer sequence from a succession of high-refractive and low-refractive layers. In the case of a layer structure of that kind, it is possible to forego the use of an absorption layer.

The reflection layer 16 is formed by a partial metal layer. The reflection layer 16 can comprise one of the following metals or an alloy of the following metals: Cr, Al, Ag, Ni, Cu and Ti. In that case the reflection layer 16 is produced by means of one of the processes shown in FIGS. 2 through 9.

In this respect it would also be possible to forego the layers 12, 13, 14 and 15 and the layer 17. It is also possible for the film element 1 to be a laminating film and to have a bonding agent layer instead of the carrier layer 11 and the protective and/or release layer 12.

FIG. 2 shows a production apparatus for manufacturing a partially metallised film element. The production apparatus has two film rollers 21 and 24, a metallisation station 22 and a demetallisation station 23.

The metallisation station 22 coats a film body fed thereto with a thin metal layer. In that situation the metallisation station 22 preferably implements coating over the full surface area involved of the film body fed thereto by means of vapor deposition. It is however also possible for the metallisation station 22 to effect only partial metallisation of the film, by a procedure whereby for example it covers parts of the film body fed thereto, by means of a vapor deposition mask.

The film body provided with a thin metal layer in that way is fed to the demetallisation station 23 which effects digital demetallisation of partial regions of the metal layer. The demetallisation station 23 is in this case designed in accordance with the apparatus shown in FIG. 3.

It is possible for the production apparatus illustrated in FIG. 2 to include still further working stations which for example serve to produce the layers 12 through 15 and 17 through 18 shown in FIG. 1. In addition the production process can also be in the form of a discontinuous process so that, between one or more of those stations, the film is rolled up and put into intermediate storage.

FIG. 3 shows an apparatus for the production of a partially metallised film element, which includes a control device 33, a voltage source 40, a ground contact element 39, a switching element 34, a carbon pin 38, a roller 37 and two guide devices 35 and 36.

FIG. 3 further shows a multi-layer film body 30 comprising a film base body 32 and a metal layer 31. The film base body 32 could be formed for example by the layers 11 through 15 of FIG. 1.

The control device 33 comprises one or more microprocessors, memory elements and peripheral units and control programs running on that hardware platform. In the execution of those control programs on the hardware platform, the functions of the control device 33, which are described hereinafter, are implemented:

From a functional point of view the control device 33 includes a data memory 332, an input unit 331, a calculating unit 333 and a control unit 334.

Stored in the memory unit 332 is a digital data set which defines the graphical shape of the partial metallisation. That digital data set is produced by the input unit 331 and stored in the memory unit 332.

The input unit 331 comprises an interface device for receiving data, for example by way of a serial or parallel bus or by way of a computer network. It is however also possible for the input unit 331 to include a graphical user interface, by means of which the graphical shape of the partial metallisation can be specified by a user.

The calculating unit 333 calculates from the digital data set stored in the memory unit 332 an associated tool path and control data for actuation of a tool in order to guide the tool in accordance with the graphical shape of the partial metallisation and to produce digital demetallisation by the tool in accordance with that graphical shape.

The control unit 334, based on those calculated data, actuates the guide devices 35 and 36 in such a way that the carbon pin 38 and the film body 30 are moved relative to each other in accordance with the tool path. In addition during that movement the control unit 334 controls the switching element 34 on the basis of those calculated data in such a way that the carbon pin 38 causes partial demetallisation of the metal layer 31 in accordance with the graphical shape of the partial metallisation by spark erosion of the metal layer 31.

The switching element 34 converts the control signals of the control unit 331 into voltage pulses which are fed to the carbon pin 38. The control element 34 comprises for example a suitable transistor circuit or a relay.

The ground contact element 39 serves to make a galvanic contact between the metal layer 31 and the voltage source 40. The ground contact element 39 comprises for example one or more rollers of a conductive material, which are pressed against the metal layer 31.

The guide device 35 comprises a servomotor with the associated electronic regulating system, which moves the carbon pin 38 transversely with respect to the longitudinal direction of the film. The guide device 36 also comprises a servomotor with associated electronic regulating system which produces a movement of the roller 37 and thus a movement of the film body 30 in the longitudinal direction.

The carbon pin 38 is guided at a precisely defined spacing above the metal layer 31. It is also possible in that respect for the guide device 35 to include a suitable regulating device which continuously monitors and adjusts that spacing.

The spacing of the carbon pin 38 from the metal layer 31 is preferably between 0 and 200 μm.

The voltage of the voltage source 40 is preferably between 3 and 4 V when the metal layer 31 comprises aluminum. The voltage of the voltage source 40 is preferably about 6 V when the metal layer 31 comprises chromium.

It is further possible for the carbon pin 38 to be replaced by a pin of another conductive material, for example silver or copper.

It is also possible that the carbon pin 38 can be moved by the guide device 35 not only in the transverse direction but also in the longitudinal direction. In that case it would also be possible to eliminate the guide device 36 and the roller 37. The carbon pin 38 could also be replaced by a laser which is actuated by the switching element 34 and which erodes the metal layer 31 by vaporisation.

Reference will now be made to FIGS. 4a through 4d and FIG. 5 to describe a further embodiment of the invention in which partial digital demetallisation is effected by the application of an etching agent.

FIG. 5 shows two film rollers 50 and 54 and three processing stations 51 through 53.

The processing station 51 is a metallisation station which is designed like the metallisation station 22 in FIG. 2.

The film shown in FIG. 4a which is made up of a carrier 42 and a film base body 43 is fed to the processing station 51. The film base body 43 can comprise for example the layers 12 through 15 in FIG. 1. It is however also possible for the film base body 43 to comprise a single carrier layer.

The processing station 51 applies a metal layer 44 to the film base body 43. The resulting film body 41 (FIG. 4b) is now passed to the processing station 52.

The processing station 52 is like the demetallisation station 23 of FIG. 2, with the difference that the ground contact element 39 and the carbon pin 38 are replaced by a device which applies an etching agent to the metal layer 4 in accordance with the actuation by the switching element 34. Advantageously in that situation the etching agent is sprayed in droplet form on to the metal layer 44. The tool actuated by the control element 34 includes for example a piezoelectric element or a vaporisation element which, when a voltage pulse is applied, produces a pressure pulse in a chamber filled with etching agent, and thereby causes droplet expulsion of etching agent through a nozzle connected to the chamber.

Caustic solutions or acids, for example caustic soda or caustic potash solution, are suitable as an etching agent for such a process, in a concentration of between 2 and 10 percent by weight.

As shown in FIG. 4c the metal layer 44 is demetallised by the application of an etching agent in regions 45.

The film body 41 processed in that way is now passed to the processing station 53 which is a washing station which removes etching agent remains and residues from the film body 41. In the washing station 53 the film body 41 is moved for example through one or more tanks filled with a solvent and then dried.

Reference will now be made to FIGS. 6a through 6c and FIG. 7 to describe a further embodiment of the invention in which digital partial demetallisation is effected by applying an etching resist.

FIG. 7 shows two film rollers 70 and 75 and four processing stations 71 through 74.

The processing station 71 is like the processing station 52, with the difference that, instead of an etching agent, an etching resist is sprayed on to the metal layer. As shown in FIG. 6a, an etching resist 64 is sprayed on to a film body 60 which includes a carrier 61, a film base body 62 and a metal layer 63.

The etching resist 64 comprises one of the following materials: PVC, acrylates, polyamides, UV-acrylates and polyurethanes.

It is also possible in that respect that the etching resist 64 is not sprayed on to the metal layer 63 but is transferred on to the metal layer 63 by means of a roller. For example it is possible for an etching resist in powder form to be partially applied to the metal layer 63 by means of the effect of heat in the manner of a laser printer or by an electroxerographic process.

The film is then fed to the processing station 72 which is a thermal treatment station which causes hardening of the etching resist 64. Depending on the respective choice of the etching resist it is also possible to forego the processing station 72.

The film is then fed to the processing station 73 which is a demetallisation station. In that processing station, the metal layer 63 is removed by means for example of an acid or a caustic solution, in the regions which are not protected by the etching resist 64. As shown in FIG. 6b therefore after processing by the processing station 73 the film has the now partial metal layer 63 only in the regions 65.

It is particularly advantageous for items of image information which are already present or which have been pre-printed such as alphanumeric or holographic diffractive or color information to be treated in register relationship with etching resist, thereby to permit accurately matching metallisation or demetallisation in the subsequent procedure.

The film is then fed to the processing station 74. The processing station 74 is a washing station which removes the etching resist layer 64 by means of a solvent and then dries the film.

It is however also possible for the film not to be fed to the processing station 74 and for the etching resist layer 64 to be left on the film. That procedure has proven to be advantageous as the etching resist layer 64 can be used as a bonding agent layer for layers which are to be further applied. The layer 64 thus performs a dual function, the function of an etching resist layer and that of a bonding agent layer.

Reference is now made to FIGS. 8a through 8c and FIG. 9 to describe a further embodiment of the invention in which digital demetallisation is effected by means of the application of a washing mask.

FIG. 9 shows two film rollers 90 and 95 and four processing stations 91 through 94.

The film shown in FIG. 8a which is made up of a film body 80 comprising a film base body 82 and a carrier 81 is fed to the processing station 91. The film base body 82 is constructed like the film base body 43 shown in FIG. 5.

The processing station 91 is like the processing station 71 of FIG. 7 with the difference that, instead of an etching resist, the processing station 91 applies a washing mask to the film body 80. As shown in FIG. 8a the processing station 91 applies a washing mask to the film body 80 in regions 85. The washing mask 83 preferably comprises a polymer-based washing mask. The materials which can be used for a washing mask can be for example methylcellulose, carboxymethylcellulose, the sodium salt of polyacrylic acid or polyvinylpyrrolidone, in addition polysugar and other native materials, which are thus film-forming and also water-soluble.

The film is then passed to the processing station 92 which causes hardening of the washing mask 83 by drying. It would also be possible in that respect to omit the processing station 92.

The film is then passed to the processing station 93 which is a metallisation station and which, as shown in FIG. 8b, applies a metal layer 84 to the supplied film body. In this case the processing station 93 can be designed like the processing station 51 of FIG. 5.

The film is then passed to the processing station 94 which is a washing station. Here the washing mask 83 and the components of the metal layer 84 which are over that layer are removed by washing and subsequent drying, thereby affording the film which is shown in FIG. 8c and in which the metal layer 84 is partially removed in the regions 85.

1. A process for the production of a partially metallized stamping, inmold or laminating film, said process comprising:
producing a digital data set, which defines the graphical shape of a partial metallization;
calculating a tool path and control data for actuation of a tool from the digital data set;
moving the tool and a single-layer or multi-layer film body relative to each other in accordance with the tool path, and
controlling the tool by the control data to partially digitally demetallize a metal layer, wherein the partial digital demetallization comprises:
applying a washing mask by the tool for partially covering the single-layer or multi-layer film body by spraying;
drying the single-layer or multi-layer film body;
providing the single-layer or multi-layer film body with the metal layer; and
partially removing the metal layer by a washing process in the region of the washing mask.

2. A process for the production of a partially metallized film element as set forth in claim 1, wherein the washing mask is applied in register relationship.

3. A process for the production of a partially metallized film element as set forth in claim 1, wherein the metal layer is a thickness of less than 1 μm.

4. A process for the production of a partially metallized film element as set forth in claim 1, wherein the metal layer is applied over the full surface area.

5. A process for the production of a partially metallized film element as set forth in claim 1, wherein the metal layer is partially applied.

6. A process for the production of a partially metallized film element as set forth in claim 1, wherein the metal layer is formed by a layer of a highly reflective material.

7. A partially metallized stamping, inmold or laminating film, wherein the partially metallized stamping, inmold or laminating film is produced in accordance with the process as set forth in claim 1.

8. A process for the production of a partially metallized film element as set forth in claim 4, wherein the metal layer is applied over the full surface area by metal deposition.
